(19) United States
(12) Patent Application Publication
(10) Pub. No.: US 2009/0050016 A1
(43) Pub. Date: Feb. 26, 2009

(54) SAB (shale ssphalt binder)

(76) Inventor: Anthony Lawrence Chirico, Essex, CT (US)

Correspondence Address: Anthony Chirico, 12 Plains Road #322, Essex, CT, 06426, US

(21) Appl. No.: 11/894,277

(22) Filed: Aug. 21, 2007

(51) Int. Cl. C08L 95/00

(52) U.S. Cl. 106/276

(57) ABSTRACT

The material component of this product is shale crude oil that is extract from shale rock.

### THE PROCESS

Fractionate whole shale oil in an atmospheric distillation column. The atmospheric bottoms will be retained for processing into SAB (shale asphalt binder) while the overhead fractions can be used for fuel or other uses.

Vacuum distills the atmospheric bottoms. Steam will be injected into the column to avoid coking. The overhead fractions, gas oils, will be usable fuel oils. The vacuum bottoms are the feedstock for the production of SAB.

Feed the vacuum bottoms to an asphalt oxidizer. Depending upon the characteristics of the SAB that is desired, inject air into the oxidizer to produce the asphalt harness required.

### SHALE OIL BINDER

The shale oil binder is made of crude oil dehydrogenated to attain a viscosity of between 1200-1800 poise at 60. degree.C. The crude shale should have sufficient basic nitrogen content so the dehydrogenated crude shale oil exhibits non-Newtonian properties when mixed with asphalt cements with nitrogen content 2-2.5% by weight.

The shale oil binder is made by a two-stage distillation followed by vacuum distillation and collecting the residual fraction. The residual fraction is dehydrogenated with air until a select viscosity, between 1200-1800 poised at 60.degree.C. is obtained.

The final binder product is a mixture 10-20% refined shale oil to 80-90% asphaltic cement.

It is the hydrogen-rich, inert environment during the heat process which (i) prevents the combustion of the valuable oils being extracted and (ii) facilitates the complete extraction of all hydrocarbons so that the shale oil binder is environmentally safe.

### EQUIPMENT

Using conventional retort systems with a mixing system. This technology simply interposes internal rotary and a distillation tower between the gasification plant and the power plant to make full utilization of the hot gas generated from the gasification.

What is claimed is:

1. SAB product has been lab and road tested in all major weather zones.

2. Resolves five major road issues—rutting, water stripping, thermal & freeze-thaw cracking, fatigue cracking and aging.

3. SAB gives roads a longer life cycle.
